(19) United States
(12) Patent Application Publication
(10) Pub. No.: US 2021/0040258 A1
(43) Pub. Date: Feb. 11, 2021

(54) CURABLE COMPOSITION

(71) Applicant: Sunstar Engineering Americas Inc., Springboro, OH (US)

(72) Inventor: Gregory Thomas CARROLL, Springboro, OH (US)

(21) Appl. No.: 16/535,879

(22) Filed: Aug. 8, 2019

(51) Int. Cl. C08G 18/10; C09D 5/20; C08G 18/48; C08G 18/67; C08G 18/72; C09D 175/16

(52) U.S. Cl. CPC C08G 18/10; C09D 5/20; C08G 18/4833; C08K 3/26; C08G 18/72; C09D 175/16; C08G 18/672

(57) ABSTRACT

An object of the present invention is to provide a masking material having excellent peeling properties even if the drying step is reduced, preferably without the drying step. There is provided a curable composition a prepolymer (A) having a urethane/urea bond and at least two acrylic polymerizable groups, and solid particles (B), and having a viscosity at 40° C. of at least 10 Pa·s and at most 300 Pa·s.

### BACKGROUND OF THE INVENTION

The present invention relates to a curable composition, a curable masking material comprising the curable composition, and a method of producing a bonded body using the curable composition.

### BACKGROUND ART

In coating various products, masking is conducted to protect a part of the substrate so that the coating is applied only to the predetermined part. Conventionally, masking has been conducted by a method of applying a film-shaped article such as a tape, but this method is not easy to automate due to the handling properties.

Instead of using the film-shaped article, it is known to apply a masking material obtained by dispersing or dissolving a resin in a solvent on a substrate (Patent Documents 1 and 2).

### Prior Technical Art

### Patent Documents

[Patent Document 1] U.S. Pat. No. 6,284,826B1
[Patent Document 2] US2003/0149164A1

### SUMMARY OF THE INVENTION

### Problems to be Solved

However, such a conventional solvent-type masking material has poor form retention, so the degree of freedom of the coating shape is inferior and the handling properties are a problem. This is a problem, particularly when using a robot or the like to automate a coating process. Further, the conventional solvent-type masking material is not economical since it requires an installation of a drying furnace to improve the peeling performance of the masking material. An object of the present invention is to provide a masking material which is excellent in the shape retention properties, excellent in freedom of a coating shape, capable of quickly being filmed, or excellent in an economic efficiency.

### Means to Solve the Problems

One embodiment of the present invention is as follows:

[1] A curable composition comprising:
a prepolymer (A) having an urethane/urea bond and at least two acrylic polymerizable groups, and
solid particles (B),
   wherein the composition has a viscosity at 40° C. of at least 10 Pa·s and at most 300 Pa·s.
   [2] The curable composition according to [1], wherein the prepolymer (A) has (poly)oxyalkylene group represented by —[—R—O—]ₓ— wherein R represents a linear or branched alkylene group and x represents an integer of 1 to 350.
   [3] The curable composition according to [1] or [2] comprising:
a polymerization initiator (C),
   wherein the polymerization initiator (C) comprises an phosphorus-containing initiator.
   [4] The curable composition according to any one of [1] to [3], comprising the prepolymer (A) at least 25% by weight and the solid particles (B) at least 10% by weight.
   [5] The curable composition according to any one of [1] to [4], comprising an antioxidant.
   [6] A curable masking material comprising the curable composition according to any one of [1] to [5].
   [7] A producing method of a bonded body comprising:
a masking step comprising masking at least a part of a substrate surface with the curable masking material according to [6] to provide a masking member,
a curing step comprising curing the masking member;
an exposing step comprising peeling off the masking member to expose a part of the substrate surface; and
a bonding step comprising bonding other member to the exposed part of the substrate surface.
   [8] The producing method according to [7], further comprising, a painting step comprising painting the substrate.
   [9] The producing method according to [7] or [8], wherein the masking step comprises applying the curable masking material at a thickness of at least 0.2 mm to mask at least a part of the substrate surface.
   [10] The producing method according to any one of [7] to [9], wherein the masking step comprises applying the curable masking material at a width of at least 5 mm to mask at least a part of the substrate surface.
   [11] The producing method according to any one of [7] to [10], wherein the substrate is a resin.
   [12] The producing method according to any one of [7] to [11], wherein a robot is used.

### Effects of the Invention

Since the curable masking material comprising the curable composition of the embodiment of the present invention is excellent in shape retention, it can be applied only to a desired part and is excellent in the degree of freedom of the coating shape. Furthermore, it is possible to form a film quickly, and is excellent in economy and peeling properties. Thus, since the curable composition of the embodiment of the present invention is excellent in handling properties, automation with a robot or the like is easily achieved, and thereby workability can be improved. Furthermore, the curable composition of the embodiment of the present invention causes less contamination in the substrate and is less likely to adversely affect the subsequent steps.

### DETAILED DESCRIPTION OF THE PREFERRED EMBODIMENTS

### <Curable Composition>

The present invention provides a novel curable composition, and the curable composition in the embodiment of the present invention comprises a prepolymer (A) and solid particles (B). The curable composition in the embodiment of the present invention may further comprise a polymerization initiator (C) and optionally other components.

### [Prepolymer (A)]

The curable composition in the embodiment of the present invention comprises a prepolymer (A). The prepolymer (A) has a urea or urethane bond and at least two acrylic polymerizable groups, and is not particularly limited as long as a curable composition aimed by the present invention can be obtained. In the present specification, “including urethane/urea bond” means including at least one of urethane bond or urea bond, and “not including urethane/urea bond” means including neither urethane bond nor urea bond.

The prepolymer (A) has at least one of a terminal urethane/urea bond (i) and an internal urethane/urea bond (ii). The prepolymer (A) may have 0 to 5, for example 1 to 5 (for example, 1 to 3) terminal urethane/urea bonds (i) and 0 to 5, for example 1 to 5 (for example, 1 to 3) internal urethane/urea bonds (ii).

The “terminal urethane/urea bond (i)” means urethane/urea bond positioned at the polymer end, and may mean a urethane/urea bond where a chemical structure extending from at least one side of the bond has a number average molecular weight at most 500. Said number average molecular weight may be at most 300, for example at most 250.

The “internal urethane/urea bond (ii)” means an urethane/urea bond positioned inside the polymer where each of chemical structures extending from both sides of the bond has at least 500. Said number average molecular weight may be at least 1000, for example, at least 1500, especially at least 2000.

The prepolymer (A) has at least one, for example, 1 to 12, preferably 1 to 8, and more preferably 1 to 6 (particularly 2 to 6) urethane/urea bonds.

The prepolymer (A) has at least 2, for example 2 to 5, preferably 2 or 3 and especially 2 acrylic polymerizable groups. The acrylic polymerizable group may be a (meth)acrylate group or a (meth) acrylamide group, preferably a (meth)acrylate group. “(meth) acryl” means acryl and methacryl.

By having a urethane/urea bond and an acrylic polymerizable group in the above number, the curing properties becomes more excellent, and the contamination of the substrate is reduced.

The prepolymer (A) may have a number average molecular weight of 1,000 to 50,000, for example, 1,500 to 30,000, preferably 2,000 to 30,000, and more preferably 3,000 to 10,000. The molecular weight in the above ranges is advantageous in terms of physical properties and viscosity after curing. A number average molecular weight (Mn) is a polystyrene conversion value measured by a gel permeation chromatography (GPC).

The prepolymer (A) may have a (poly)oxyalkylene group. The number average molecular weight (Mn) of the (poly) oxyalkylene group may be 500 to 30,000, preferably 1,000 to 20,000, and more preferably 1,500 to 15,000. The molecular weight in the above ranges is advantageous in terms of physical properties and viscosity after curing.

The prepolymer (A) preferably comprises (poly)oxyalkylene group represented by the formula: —[R—O—]ₓ— (wherein R is a linear or branched alkylene group and x is an integer of 1 to 350). Examples of the alkylene group for R include a C1-6 alkylene group such as ethylene group, propylene group, trimethylene group, n-butylene group (tetramethylene group), i-butylene group, s-butylene group, t-butylene group, and the like. Among these, from the viewpoint of physical properties after curing, ethylene group and propylene group are preferable.

The prepolymer (A) may have a (poly) oxyalkylene group derived from a polyether polyol compound. The polyether polyol compounds may be obtained by addition-polymerizing alkylene oxides such as ethylene oxide, propylene oxide and butylene oxide from polyhydric alcohols such as ethylene glycol, propylene glycol, glycerin, trimethylolpropane, pentaerythritol, sorbitol and sucrose. The (poly) oxyalkylene group may have an unreacted hydroxy group.

The prepolymer (A) may have a group derived from a polyisocyanate compound (e.g. diisocyanate). The polyisocyanate compound may be an aliphatic polyisocyanate or an aromatic polyisocyanate, from the viewpoint of physical properties after curing, an aliphatic polyisocyanate is preferable, and an alicyclic polyisocyanate is particularly preferable. The alicyclic polyisocyanates may be monocyclic alicyclic polyisocyanates or polycyclic alicyclic polyisocyanates (e.g. bicyclic alicyclic polyisocyanates, tricyclic alicyclic polyisocyanates, bridged cyclic alicyclic polyisocyanates, etc.).

Specific examples of the aromatic polyisocyanate as a raw material include tolylene diisocyanate (2,4- or 2,6-tolylene diisocyanate or a mixture thereof) (TDI), phenylene diisocyanate (m-, p-phenylene diisocyanate or a mixture thereof, 4,4′-diphenyl diisocyanate, diphenylmethane diisocyanate (4,4′-, 2,4′- or 2,2′-diphenylmethane diisocyanate or a mixture thereof) (MDI) 4,4′-toluidine diisocyanate (TODI), 4,4′-diphenylether diisocyanate, xylylene diisocyanate (1,3- or 1,4-xylylene diisocyanate or mixtures thereof) (XDI), tetramethyl xylylene diisocyanate (1,3- or 1,4-tetramethyl xylylene diisocyanate or mixtures thereof) (TMXDI), co, ω′-diisocyanate-1,4-diethylbenzene, naphthalene diisocyanate (1,5-, 1,4- or 1,8-naphthalene diisocyanate or mixture thereof) (NDI), triphenylmethane triisocyanate, tris (isocyanate phenyl) thiophosphate, polymethylene polyphenylene polyisocyanate, nitrodiphenyl-4,4′-diisocyanate, 3,3′-dimethyldiphenylmethane-4,4′-diisocyanate, 4,4′-diphenylpropane diisocyanate, and 3,3′-dimethoxydiphenyl-4,4′-diisocyanate, and multimers thereof (dimer, trimer, pentamer, heptamer, uretidine dione, ureitone modified product, polycarbodiimide etc.), biuret modified product, block product and other derivatives.

Specific examples of the aliphatic polyisocyanate as a raw material include acyclic aliphatic polyisocyanates such as isocyanate, trimethylene diisocyanate, 1,2-propylene diisocyanate, butylene diisocyanate (tetramethylene diisocyanate, 1,2-butylene diisocyanate, 2,3-butylene diisocyanate, 1 2,3-butylenediisocyanate), hexamethylene diisocyanate, pentamethylene diisocyanate, 2,2,4-trimethylhexamethylene diisocyanate, 2,4,4-trimethylhexamethylene diisocyanate, 2,6-diisocyanate methyl capate, lysine diisocyanate, lysine ester triisocyanate, 1,6,11-undecane triisocyanate, 1,3,6-hexamethylene triisocyanate, trimethylhexamethylene, decamethylene diisocyanate, etc.;

monocyclic alicyclic polyisocyanates such as 1,3-cyclopentadiisocyanate, 1,3-cyclopentene diisocyanate, cyclohexane diisocyanate (1,4-cyclohexane diisocyanate, 1,3-cyclohexane diisocyanate), 3-isocyanatomethyl-3,5,5-trimethylcyclohexyl isocyanate (isophorone diisocyanate, IPDI), methylenebis (cyclohexyl isocyanate (4,4′-, 2,4′- or 2,2′-methylenebis (cyclohexyl isocyanate or their mixtures) (hydrogenated MDI), methylcyclohexane diisocyanate (methyl-2,4-cyclohexane diisocyanate, methyl-2,6-cyclohexene diisocyanate, bis (isocyanatomethyl) cyclohexane (1,3- or 1,4-bis (isocyanatomethyl) cyclohexane or a mixture thereof) (hydrogenated XDI), dimer acid diisocyanate, transcyclohexane 1,4-diisocyanate, hydrogen added tolylene diisocyanate (hydrogenated TDI), hydrogenated tetramethyl xylylene diisocyanate (water-added TMXDI), etc.; multicyclic (e.g. bridged cyclic) alicyclic polyisocyanates such as norbornene diisocyanate, norbornane diisocyanate methyl, bicycloheptane triisocyanate, diisocyanate methyl bicyclo heptane, di (diisocyanatomethyl) tricyclodecane e.c.; and multimers thereof (dimers, trimers, pentamers, trimers, etc.), uretidine dione, polycarbodiimides, modified biuret, block compounds, and other derivatives thereof.

The polyisocyanate compound as a raw material has, for example, 2 to 8, preferably 2 to 4 and more preferably 2 isocyanate groups (diisocyanate).

The prepolymer (A) may have a group derived from a polyisocyanate compound having a number average molecular weight of 50 to 2,000, for example, 100 to 1,500, preferably 150 to 1,000.

The prepolymer (A) can be obtained, for example, by reacting a compound having a urethane/urea bond (e.g. urethane/urea prepolymer) with a compound having an acrylic polymerizable group. Specifically, for example, this is as follows. A compound having at least two of hydroxy group or amino group (e.g. a diol) is reacted with a diisocyanate compound to obtain a urethane/urea prepolymer comprising a urethane/urea bond and at least two isocyanate groups. A prepolymer (A) can be obtained by reacting the two isocyanate groups with a hydroxy group or amino group of a compound having a hydroxy group or an amino group and an acrylic polymerizable group.

Specific examples of the compound having a hydroxy group or an amino group and an acrylic polymerizable group as a raw material include hydroxy group-containing (meth)acrylic monomers such as 2-hydroxyethyl (meth)acrylate, 2-hydroxypropyl (meth)acrylate, 2-hydroxyethyl (meth)acrylamide, 2-hydroxypropyl (meth) acrylamide, 6-hydroxyhexyl (meth)acrylate, 4-hydroxybutyl (meth)acrylate, polypropylene glycol mono (meth)acrylate and 1,6-hexanediol mono (meth)acrylate, etc.; amino group-containing (meth)acrylic monomers such as aminoethyl (meth)acrylate, aminomethyl (meth)acrylate, aminoethyl (meth) acrylamide, aminomethyl (meth) acrylamide, etc.

The prepolymer (A) may also be obtained by reacting a compound having an isocyanate group (for example, polyisocyanate (for example, diisocyanate) with a hydroxy group or an amino group of a compound having a hydroxy group or an amino group and an acrylic polymerization group.

Alternatively, the prepolymer (A) may also be obtained by reacting a compound having a hydroxy group or an amino group with a compound having an isocyanate group and an acrylic polymerizable group. As a raw material of a prepolymer (A), the urethane/urea prepolymer having an isocyanate group may also be used. Specific examples of the compound having an isocyanate group and an acrylic polymerization group as a raw material, include 2-isocyanate ethyl (meth)acrylate (Karenz MOI manufactured by Showa Denko K. K.), 3-isocyanate propyl (meth)acrylate, 4-isocyanate butyl(meth)acrylates and block compound thereof.

The prepolymer (A) may be chain-extended. The chain-extended prepolymer (A) is obtained by reacting a prepolymer (for example, an isocyanate group-containing urethane/urea prepolymer) of the prepolymer (A) with a chain extender having at least two functional groups. As chain extenders, chain extenders having at least two functional groups, preferably at least two of a hydroxy group and an amino group are preferably used. Specific examples of the chain extender include, for example, ethylene glycol, diethylene glycol, polyethylene glycol (preferably polyethylene glycol having a molecular weight of at most 500), propylene glycol, polypropylene glycol (preferably polypropylene glycol having a molecular weight of at most 500), butanediol, dimethylol cyclohexane, methyliminodiethanol, dimethylol propionic acid, ethylene diamine, hexamethylene diamine, polyoxyethylene diamine (preferably polyoxyethylene diamine having a molecular weight of at most 500), polyoxypropylene diamine (preferably polyoxypropylene diamine having a molecular weight of at most 500) and the like.

The prepolymer (A) may be a compound, for example, represented by the following formula (I):

R¹(—(U—R²)ₙ—U—R³—X)ₘ formula (I)

[In formula (I), R¹ is a m-valent (poly) oxyalkylene group, and each of R² and R³ is independently a divalent aliphatic hydrocarbon group or a divalent alicyclic hydrocarbon group, a divalent aromatic hydrocarbon group or a divalent(poly)oxyalkylene group, U is a urethane/urea bond, —X is —O—C(═O) CH₂═CH₂, —O—C(═O)—C(CH₃)═CH₂, —NH—C(═O)—CH═CH₂, —NH—C(═O)—C(CH₃)═CH₂, and n is an integer of 0 to 5 and m is an integer of 2 to 6.]

Examples of formula (I) representing the prepolymer (A) include, for example, the following (the meaning of the abbreviations is as described above).

R¹(—U—R³—X)₂

R¹(—U—R²—U—R²—U—R³—X)₂

R¹(—U—R²—X)₃

R¹(—U—R²—U—R³—X)₃

R¹(—U—R²—U—R²—U—R³—X)₃

R¹(—U—R³—X)₄

R¹(—U—R²—U—R³—X)₄

R¹(—U—R²—U—R²—U—R³—X)₄

R¹ in the formula (I) is a m-valent (poly) oxyalkylene group, preferably has a repeating unit represented by the formula: —[R^{a}—O-]ₚ— (wherein, R^{a} is a linear or branched alkylene group, and p is an integer of 1 to 350). As an alkylene group of R^{a}, for example, a C₁₋₆ group such as an ethylene group, a propylene group, a trimethylene group, a n-butylene group (tetramethylene group), an i-butylene group, a s-butylene group, a t-butylene group, etc. Among these, from the viewpoint of physical properties after curing, an ethylene group and a propylene group are preferable.

R² and R³ in the formula (I) are each independently a divalent aliphatic hydrocarbon group, a divalent aromatic hydrocarbon group or a divalent polyoxyalkylene group. n×m R² preferably comprise a divalent aliphatic hydrocarbon group, and may consist of both a divalent aliphatic hydrocarbon group and a divalent aromatic hydrocarbon group, and may consist only of a divalent aliphatic hydrocarbon group.

Examples of the divalent aliphatic hydrocarbon group of R² and R³ in the formula (I) include acyclic aliphatic hydrocarbon groups such as linear or branched C₂₋₁₂ alkylene groups such as ethylene group, propylene group, trimethylene group, n-butylene group (tetramethylene group), i-butylene group, s-butylene group, t-butylene group, pentamethylene group, hexamethylene group, heptamethylene group, octamethylene group and trimethylhexamethylene group; alicyclic hydrocarbon group such as C₃₋₈ cycloalkanediyl groups such as a cyclohexane-1,3-diyl group, a cyclohexane-1,4-diyl group, a cycloheptane-1,3-diyl group and a cycloheptane-1,4-diyl group; C₃₋₈ cycloalkanedimethylene groups such as a cyclohexane-1, 3-dimethylene group, a cyclohexane-1, 4-dimethylene group; di C₃₋₈ cycloalkylmethanediyl groups such as a dicyclohexylmethane-4,4′-diyl group; a norbornene-diyl group and a isophoronediyl group. The prepolymer (A) may comprise both a divalent aliphatic hydrocarbon group and a cyclic aliphatic hydrocarbon group. In Formula (I), at least R³ may be an aliphatic hydrocarbon group.

Examples of the divalent aromatic hydrocarbon group of R² and R³ in the formula (I) include benzenediyl groups such as a benzene-1,4-diyl group and a benzene-1,3-diyl group; diphenylmethane-4,4′-diyl group such as a diphenylmethanediyl group; phenylene groups such as a m-phenylene group, a p-phenylene group; methyl phenylene groups such as a toluene-2,4-diyl group and a toluene-2, 6-diyl group; naphthylene groups such as a 1,5-naphthylene group and a 2,6-naphthylene group; benzenedimethylene groups such as a benzene-1,3-dimethylene group, a benzene-1,4-dimethylene group; bisphenylene groups such as a 4,4′-bisphenylene group; and dimethylbisphenylene groups such as a 3,3′-dimethyl-4,4′-bisphenylene group.

The divalent (poly)oxyalkylene group of R² and R³ in the formula (I) may be a group having a repeating unit represented by the formula: —[R^{b}—O—]_{q}— (wherein R^{b} is a linear or branched alkylene group, and q is a group an integer of 1 to 350 (preferably 1 to 50)).

—U— is selected from the group consisting of —NH(C═O)O—, —O—(C═O)NH— or —NH—(C═O)NH— depending on the combination of raw materials.

n is an integer of 0 to 5, and may be an integer of 1 to 4, preferably 1 or 2, particularly 1.

m is an integer of 2 to 6, and may be an integer of 2 to 4, preferably 2 or 3, particularly 2.

### (Viscosity of Prepolymer (A))

The viscosity of the prepolymer (A) at 40° C. may be at least 1 Pa·s, for example, at least 10 Pa·s, preferably at least 20 Pa·s. The viscosity the prepolymer (A) at 40° C. may be at most 200 Pa·s, for example, at most 150 Pa·s, preferably at most 100 Pa·s. When the viscosity at 40° C. of the prepolymer (A) is in the above range, the coating properties and the peeling properties become more preferable. The measuring method of viscosity is shown in the Example.

### [Solid Particles (B)]

The curable composition in the embodiment of the present invention comprises solid particles (B). The solid particles (B) are particles that are solid at normal temperature, and are not particularly limited as long as a curable composition targeted by the present invention can be obtained. Examples of solid particles (B) may include, carbonates, oxides or hydroxides of alkali metals or alkaline earth metals such as calcium carbonate, calcium hydroxide, calcium oxide, magnesium hydroxide etc; silica such as fumed silica and precipitated silica; carbon such as carbon black, graphite, etc.;

mineral fillers such as alumina, talc, mica and clay, etc.; glass beads; balloons such as shirasu balloon, glass balloon, silica balloon. plastic balloon, etc.; inorganic fibers such as glass fiber, metal fiber, etc.; organic fibers such as polyethylene fibers and polypropylene fibers; ceramic fillers such as aluminum borate, silicon carbide, silicon nitride, potassium titanate, magnesium borate and titanium diboride, etc.; and needle-like crystalline fillers such as chrysotile and wollastonite etc. The solid particles (B) may be surface-treated (e.g. fatty acid-treated) particles.

The median particle diameter of the solid particles (B) may be at least 0.003 μm, for example, at least 0.5 μm. The median particle diameter of the solid particles (B) is preferably at most 20 μm, more preferably at most 10 μm, and still more preferably at most 5 μm. The median particle diameter is the 50% diameter of the weight cumulative particle diameter distribution measured by a laser diffraction/scattering type particle diameter distribution measuring device.

The solid particles (B) may be carbonates, oxides or hydroxides of an alkali metal or alkaline earth metal, silica, or alumina or the like, from the viewpoint of improving coating properties and peeling properties, among them, carbonate salts, in particular calcium carbonate, are preferred.

### [Polymerization Initiator (C)]

The curable composition of the embodiment of the present invention may comprise a polymerization initiator. The polymerization initiator may be, for example, an initiator that is a photoinitiator and/or a thermal initiator, and is not particularly limited as long as a curable composition targeted by the present invention is obtained. When a curable composition is used for photomasking, a photoinitiator is usually used. Examples of polymerization initiators include benzoin initiators such as benzoin, benzoin methyl ether, benzoin ethyl ether, benzoin n-propyl ether, benzoin isopropyl ether, benzoin butyl ether, 2-allylbenzoin, 2-chlorobenzoin, etc.; acetophenone initiators such as 1-hydroxy-cyclohexyl-phenyl ketone, diethoxyacetophenone, hydroxyacetophenone, 2-hydroxy-2-methyl-1-phenylpropan-1-one, α-aminoacetophenone, 2,2-dimethoxy-1,2-diphenylethane-1-on, etc.; benzophenone initiators such as benzophenone, 4-methylbenzophenone, 4-chlorobenzophenone, 4-chlorobenzophenone, etc.; thioxanthone initiators such as 2-methyl thioxanthone, 2-isopropyl thioxanthone, 2-chlorothioxanthone etc.; azo initiators such as azobisisobutyronitrile; peroxide initiators such as benzoyl peroxide; quinone initiators such as anthraquinone, 2-chloroanthraquinone, phenanthrene, etc.; phosphorus-containing initiators such as: phosphine oxide initiator such as bis (2,4,6-trimethylbenzoyl) phenyl phosphine oxide, bis (2,6-dimethoxybenzoyl)-2,4,4-trimethyl-pentyl phosphine oxide and phosphinate initiators such as ethyl phenyl (2,4,6-trimethylbenzoyl) phosphinate, etc.

The polymerization initiator may comprise a phosphorous-containing initiator, in particular a phosphorous-containing aromatic initiator (e.g. aromatic phosphinate). When the curable composition is applied thick (for example, a thickness of at least 0.2 mm, particularly at least 0.5 mm), the light transmittance decreases exponentially, so there may be problems that the entire curable composition is difficult to cure. In the curable composition of the embodiments of the preset invention, it is possible to have both the curing properties to the deep part and the rapid curing properties by combining the prepolymer (A), solid particles (B) and the phosphorus-containing initiator. This is particularly effective when the curable composition is thick-painted. The peeling properties become better by performing the subsequent steps such as baking coating after sufficient curing.

### [Other Ingredients]

The curable composition of the embodiment of the present invention may comprise other components. The other components are not particularly limited as long as the curable composition aimed by the present invention is obtained.

The curable composition may comprise, as one of the other components, other monomers (e.g. non-crosslinkable (meth)acrylic monomers, crosslinkable (meth)acrylic monomers, etc.) other than the prepolymer (A). As the other monomers, any monomers used for a curable resin composition, particularly for curable masking materials may be used. Examples of the other monomers include alkyl(meth)acrylates such as methyl(meth)acrylate, butyl(meth)acrylate, hexyl(meth)acrylate, etc.; hydroxy group comprising (meth)acrylate such as hydroxymethyl(meth)acrylate, hydroxyethyl(meth)acrylate, etc.; ether group-containing (meth)acrylates such as diethylene glycol monoethyl ether acrylate, dipropylene glycol monoethyl ether acrylate etc.; epoxy group-containing (meth)acrylates such as glycidyl(meth)acrylate, (3,4-epoxycyclohexyl)methyl(meth)acrylate, etc.; aromatic group-containing monomers such as styrene, 2-hydroxy-3-phenoxy propyl acrylate, etc.; isocyanate group-containing monomers such as 2-isocyanatoethyl(meth)acrylate, etc.; Si group-containing monomers such as trimethylsilyl acrylate, trialkoxy silyl acrylate, etc.; acid functional group-containing monomers such as (meth) acrylic acid, 3-(acryloyloxy)propane-1-sulfonic salts thereof, etc.; cyclic group-containing monomers such as adamantyl acrylate and cyclohexyl acrylate, etc.; fluoromonomers such as 1H, 1H, 2H, 2H-tridecafluoro-n-octyl(meth)acrylate, etc.; amide monomers such as acrylamide, N-alkyl acrylamide, etc.; and crosslinkable monomers such as polyalkylene glycol di(meth)acrylate, N, N′-methylenebis(meth)acrylamide, diacetone acrylamide, etc.

The curable composition may not comprise other monomers. The curable composition may not comprise the non-crosslinkable (meth)acrylic monomer. Herein, the non-crosslinkable (meth)acrylic monomer is a monomer which cannot cause a crosslinking reaction, for example, (meth) acrylic monomers which have only one (meth)acrylate group or (meth) acrylamide group such as a alkyl mono (meth)acrylate and alkyl mono (meth) acrylamide.

The curable composition may comprise an antioxidant as one of the other components. Examples of the antioxidant include phenolic antioxidants (e.g. hindered phenols etc.), aromatic amine antioxidants, sulfur antioxidants, phosphorus antioxidants and the like. By comprising the antioxidant, the peeling properties of the masking material is improved even after high temperature heating.

The curable composition includes other components in an appropriate amount range such as a colorant (e.g. bengara, titanium oxide, other color pigments, dyes, etc.), a solvent (e.g. water, polar organic solvents, nonpolar organic solvents, etc.), silane compounds (e.g. silane compounds having a functional group such as an amino, group, a mercapto group, an epoxy group, a (meth) acrylic group, a vinyl group, etc.), epoxy compounds which may have a polyoxyalkylene group, plasticizers, UV absorbers/light stabilizers (e.g. benzotriazole, hindered amines, etc.), thixotropic agents (e.g. colloidal silica, organic bentonite, fatty acid amide, hydrogenated castor oil, etc.), viscosity modifiers, sensitizers, polymerization inhibitors and the like.

### [Formulation of Curable Composition]

The amount of the prepolymer (A) may be at least 25% by weight, for example, at least 30% by weight, preferably at least 45% by weight relative to the curable composition. The amount of prepolymer (A) may be at most 90% by weight, for example at most 75% by weight, preferably at most 70% by weight, relative to the curable composition.

The amount of solid particles (B) may be at least 10% by weight, at least 25% by weight, for example, at least 30% by weight, at least preferably 45% by weight, relative to the curable composition. The amount of solid particles (B) may be at most 80% by weight, for example at most 75% by weight, preferably at most 70% by weight, relative to the curable composition.

The amount of the polymerization initiator (C) may be at least 0.01% by weight, for example, at least 0.05% by weight, preferably at least 0.1% by weight, relative to the curable composition. The amount of the polymerization initiator (C) may be at most 5% by weight, for example, at most 4% by weight, preferably at most 2.5% by weight, relative to the curable composition.

The amount of the other components may be at least 0.1% by weight, for example, at least 1% by weight, relative to the curable composition. The amount of the other components may be at most 25% by weight, for example at most 10% by weight, relative to the curable composition. The weight % may be based on the part excluding the solvent.

The amount of other monomers may be at most 10% by weight, for example, at most 4% by weight, preferably at most 1% by weight relative to the curable composition. The amount of the non-crosslinkable (meth)acrylic monomers in the curable composition may be at most 12.5% by weight, for example at most 7.5% by weight (e.g. at most 4.5% by weight), preferably at most 3% by weight (e.g. at most 2% by weight) relative to the curable composition. When the amount of the other monomers is in the above range, unreacted substances are less likely to remain in the cured product, and the substrate is less likely to be contaminated when peeling off the masking material.

The amount of the antioxidant may be at least 0.01%, for example, at least 0.1%, preferably at least 0.3%, and at most 7.5% by weight, for example, at most 3% by weight relative to the curable composition.

### [Viscosity of Curable Composition]

The viscosity of the curable composition at 40° C. is at least 10 Pa·s, and may be at least 30 Pa·s, for example, at least 50 Pa·s, preferably at least 100 Pa·s. The viscosity of the curable composition at 40° C. is at most 300 Pa·s and may be at most 250 Pa·s, for example, at most 200 Pa·s, preferably at most 180 Pa·s. The TI (Thixotropy Index) value at 40° C. of the curable composition is at least 0.3, and may be at least 0.6, for example, at least 0.8, preferably at least 1. In addition, the TI value at 40° C. of the curable composition is at most 3, and may be at most 2.5, for example, at most 2, preferably at most 1.8. The curable compositions of embodiments of the present invention may be in the form of a fluid that exhibits the above viscosity or TI value. When the viscosity or TI value of the curable composition is in the above range, the coating properties and the peeling properties are more preferable. The TI value is calculated from the ratio of the viscosity at 0.42 rpm to the viscosity at 4.2 rpm.

### <Curable Masking Material>

The curable masking material of the embodiment of the present invention is not particularly limited as long as it comprises the curable composition and can mask part of the substrate. By using a masking material to mask the substrate surface during coating, it is possible to prevent the masked substrate surface from being applied.

### <Method for Producing Bonded Body>

The present invention further provides a new method of producing a bonded body, which comprises a masking step, a curing step, an exposing step, and a bonding step. Furthermore, the method may further comprise a painting step after the masking step (preferably after the curing step) and before the exposing step.

In the method for producing the bonded body according to an embodiment of the present invention, it is possible to form a film with reducing the drying step or without the drying step although it may be subjected to a drying step if necessary. From the viewpoint of workability, it is preferable to reduce the drying step, and more preferably, conduct without the drying step. Therefore, the drying oven may not be required.

### [Masking Step]

The masking step comprises providing a masking member that masks at least a part of the substrate surface. The masking member is obtained by applying the above-mentioned curable masking material on the substrate surface.

The curable masking material may be applied in the form of wide thick film beads. The shape of the nozzle may be a round bead nozzle, a wide and thin bead nozzle, a flat nozzle and a fan-like nozzle, and may be selected according to the purpose. If a certain degree of wide masking is required, a wide and thin bead nozzle or fan-like nozzle is preferred. It is also possible to coat in a wider width by a method using a shot nozzle, a slit nozzle or the like or a method using a swirl coating, a spray coating with adjusting the discharge speed. For example, the curable composition may be supplied on the substrate from a container via a material supply hose with the use of a supply pump. It is possible to conduct an automatic coating to a target part with a coating dispenser fixed to a robot. A metering pump may be placed between the feed pump and the dispenser so as to stabilize the supplied amount of the masking material. A feed pump or dispenser with a metering device may be used.

A coating thickness of the curable masking material may have at least 0.1 mm, for example, at least 0.2 mm, preferably at least 0.5 mm, more preferably at least 1 mm, especially at least 1.5 mm, particularly at least 3 mm, more particularly at least 5 mm. The coating thickness of the curable masking material may be at most 30 mm, for example, at most 15 mm, preferably at most 10 mm. When the coating thickness is in the above range, the painting film and the masking material after curing hardly become integrated after painting, so it becomes easy to peel off only the masking material. Thereby, for example, it becomes easier to automatically peel off the masking material with a gripper, a peeler and the like equipped in the robot.

A coating width of the curable masking material may have at least 3 mm, for example, at least 5 mm, and preferably at least 10 mm. The coating width of the curable masking material may be at most 75 mm, for example at most 50 mm, preferably at most 30 mm.

The above-mentioned coating thickness and coating width of the curable masking material may mean the thickness and width after curing or coating.

The substrate material is not limited and may be metal (for example, steel), resin (for example, acrylic resin, olefin resin (typically polypropylene), polyamide resin, polyimide resin, polycarbonate resin, etc.), glass, ceramic and the like.

### [Curing Step]

The curing step comprises curing the masking member. The masking member in the embodiment of the present invention is excellent in fast curing. In addition, in the embodiment of the present invention, the cured material obtained by curing the masking member has moderate flexibility and toughness, which does not easily break at the time of peeling.

The curing of the masking member in the embodiment of the present invention is conducted by activating the polymerization initiator and advancing the polymerization. Curing of the masking member may be conducted by light irradiation or heating of the curable composition. From the viewpoint of workability, curing is preferably conducted by light irradiation (for example, UV irradiation, visible light irradiation, etc.).

When the curable masking material is photocurable, it may be cured by passing the material through a conveyor having a light source (for example, a UV light source or a visible light source) inside, or a method of irradiating a coating portion with a robot holding a light source. Furthermore, the dispenser for coating and the light source may be equipped with the same robot to simultaneously perform coating and curing. As a light source, a conventional light source such as an incandescent lamp, a fluorescent lamp, a halogen lamp, a mercury lamp, and a xenon lamp may, etc. or an LED light source may be used.

The wavelength used for photocuring may be 100 to 900 nm, for example 200 to 500 nm, preferably 300 to 450 nm. The irradiance may be at least 100 mW/cm², for example, at least 200 mW/cm² and may be at most 100 W/cm², for example at most 50 W/cm². Since the curable composition in the embodiment of the present invention has improved rapid curing properties, the workability can be improved. From the viewpoint of workability, the light irradiation time may be at most 1 minute, preferably at most 30 seconds, more preferably at most 10 seconds, still more preferably at most 5 seconds, still more preferably at most 3 seconds, particularly preferably at most 1 second and may be at least 0.1 seconds, for example, at least 0.3 seconds.

When the curable masking material is thermosetting, it may be cured by using an oven, a hot air apparatus, a near infrared lamp, or a robot equipped with these. The heating temperature may be 80 to 150° C., preferably 60 to 130° C., more preferably 70° C. to 120° C. The heating time for curing may be less than 1 minute, preferably less than 30 seconds, more preferably less than 10 seconds, from the viewpoint of workability.

Conventionally, when the masking material is applied as a thick film, even if it is subjected to curing treatment such as light irradiation or heating, the entire masking material cannot be cured, and there is a problem that the residue adheres to the substrate. The curable masking material in the embodiment of the present invention can be cured quickly and has adequate mechanical strength after curing and heating, and therefore, the entire masking material can be peeled off integrally without break even when applied as a wide and thick film. Furthermore, since the curable masking material in the present invention does not contaminate the substrate after peeling, the adhesion is not adversely affected when the adhesive is applied to the exposed surface.

### [Painting Step]

The painting step comprises painting substrate surface after the masking step (preferably after the curing step) and before the exposed step. The painting may be conducted by various methods such as brush painting, spray painting, dip painting, powder painting, electrostatic painting, photocuring painting, and baking painting. For painting and drying, it may be heated to at least 100° C., for example, at least 120° C., at least 150° C., or at least 180° C. The heating time may be 30 seconds to 600 minutes, for example, 5 minutes to 150 minutes.

### [Exposing Step]

The exposing step comprises peeling off the masking member after curing to expose at least a part of the substrate surface.

### [Bonding Step]

The bonding step comprises bonding other member to the exposed part of the substrate surface. An adhesive may be applied to the substrate surface to bond other components. The substrate surface may be subjected to pretreatment such as primer treatment before applying the adhesive. Using the curable masking material in the embodiment of the present invention, the adhesiveness between the substrate surface and other members is excellent since an adhesion inhibitory component does not remain on the substrate surface after peeling off the masking member from the substrate. Other member may be bonded to the substrate surface without pretreatment such as a primer treatment.

### EXAMPLES

The present invention will be more specifically described below by showing Examples and Comparative Examples, but the present invention is not limited by these examples. In addition, parts and % are based on weight parts unless otherwise specified.

The test methods are as follows.

### [Viscosity Measurement]

Viscosity measurement was conducted at a rotation speed of 0.42 rpm and 40° C. using a rheometer (DHR-3 manufactured by TA instruments) equipped with a 20 mm plate.

### [Photocuring]

The photocuring was conducted under the following conditions.
Wavelength: 395 nmUV
Light source: LED14 W/cm² distance 4 inch
Light irradiation time: 3 seconds

### [Painting]

Painting was conducted by baking painting under the following conditions.
Paint: Acrylic paint
Condition: 1 hour at 100° C. or 160° C.

### [Tensile Strength]

A cured sheet material about 1 mm thick was prepared according to JIS K 6251 or ASTM D412. The sheet material was then punched to prepare the sheet of dumbbell shape No. 2 and the tensile strength was measured at speed 300 mm/min with a testing machine.

### [Elongation]

The maximum elongation when measuring the tensile strength was measured according to JISK6251 or ASTM D412.

### [Evaluation of Peeling Properties]

The curable composition was applied to a substrate (steel plate) at the predetermined thickness and UV-cured in the above condition, and the cured material was peeled off from the substrate by hand to evaluate peeling properties. In addition, it was also evaluated whether a break easily occurred when peeling by hand. Evaluation criteria are as follows.
∘ (Good): Easily peeled off by hand without a break and no residue are remained on the adhered surface
Δ (Satisfactory): strongly adhered to the substrate and a residue remained slightly on the adhered surface
x (Poor): easily broken and strongly adhered to the substrate and a residue remained on at least 50% of the adhered surface.
   [Adhesiveness after Removal of Masking Member]

The adhesion test was conducted after coating the masking material, curing painting and removal of the masking member. The primer was applied to the substrate surface. After 5 minutes, the adhesive was applied thereto. After 7 days of curing under a standard condition (20° C.×65%), the adhesion test was conducted. The adhesion test was conducted according to the peel adhesion evaluation method of JASO M 338-89.
Primer: 435-97 (SunStar Engeneering, Inc.)
Adhesive: Penguin Cemment #560 (SunStar Engeneering, Inc.) Evaluation criteria are as follows.
∘ (Good): cohesive failure
Δ (Satisfactory): at least 50% cohesive failure (partially interface failure)
x (Poor): at least 50% interface failure

The synthesis methods are as follows.

### [Synthesis of Urethane Prepolymer D]

In a reaction kettle equipped with a stirring blade, 100 parts by weight of polypropylene glycol (Poly G 20-28 molecular weight 4000, OH group number 28 manufactured by Arch Chemicals) and 10.5 parts by weight (2 mol) of TMDI (trimethylhexamethylene diisocyanate) were charged, and the temperature was raised to 70° C. while stirring. The reaction was conducted at this temperature for 7 hours, and the NCO % was measured to be 1.90% by weight. Then 5.8 parts (2 mol) of HEA (2-hydroxyethyl acrylate) were charged and the reaction was conducted for a further 7 hours at this temperature. After confirmed that the absorption of NCO disappeared in the infrared absorption spectrum, urethane diacrylate D as a radically polymerizable oligomer; number average molecular weight: about 4420 were obtained.

### [Synthesis of Urethane Prepolymer E]

In a reaction kettle equipped with a stirring blade, 100 parts by weight of polypropylene glycol (Poly G 20-37 molecular weight 3000, OH group value 37 Arch Chemicals) and 14 parts by weight (2 mol) of IPDI (isophorone diisocyanate) were charged, and the temperature was raised to 70° C. while stirring. The reaction was conducted at this temperature for 7 hours, and the NCO % was measured to be 2.32% by weight. Then, 7.7 parts by weight (2 mol) of HEA (2-hydroxyethyl acrylate) was charged, and the reaction was conducted at this temperature for a further 7 hours. After confirmed that the absorption of NCO disappeared in the infrared absorption spectrum, urethane diacrylate E as a radically polymerizable oligomer; number average molecular weight: about 3620 were obtained.

### [Synthesis of Urethane Prepolymer F]

In a reaction kettle equipped with a stirring blade, 100 parts by weight of polypropylene glycol (Poly G 20-28 molecular weight 4000, OH group value 28 Arch Chemicals) and 8.6 parts by weight (2 mol) of HDI (hexamethylene diisocyanate) were charged, and then the temperature was raised to 70° C. while stirring. The reaction was conducted at this temperature for 7 hours, and the NCO % was measured to be 1.94 weight %. Then, 5.8 parts by weight (2 mol) of HEA (2-hydroxyethyl acrylate) were charged, and the reaction was conducted at this temperature for a further 7 hours. After confirmed that the absorption of NCO disappeared in the infrared absorption spectrum, urethane diacrylate F as a radically polymerizable oligomer; number average molecular weight: about 4340 were obtained.

### Examples 1 to 13, Comparative Examples 1 to 2

The raw materials shown in Table 1 were mixed by the planetary mixer in the formulation (parts by weight) shown in Table 1 to obtain a curable composition. The above test was conducted with the obtained curable composition. The test results are shown in Table 1.

TABLE 1

| | | | | | | | | | | | | | | | Comparative | |
|---|---|---|---|---|---|---|---|---|---|---|---|---|---|---|---|---|
| | | Example | | | | | | | | | | | | | Example | |
| | | 1 | 2 | 3 | 4 | 5 | 6 | 7 | 8 | 9 | 10 | 11 | 12 | 13 | 1 | 2 |
| Ingre- | Urethane Diacrylate A | 38.8 | 48.8 | | | | | | 38.3 | 33.3 | | 39.5 | 38.3 | | | |
| dient | Urethane Diacrylate B | | | 38.8 | | | | | | | 45 | | | | | |
| | Urethane Diacrylate C | | | | 38.8 | | | | | | | | | | | |
| | Urethane Diacrylate D | | | | | 58.2 | | | | | | | | 58.2 | | |
| | Urethane Diacrylate E | | | | | | 58.2 | | | | | | | | | |
| | Urethane Diacrylate F | | | | | | | 80 | | | | | | | | |
| | Non-urethane Monoacrylate | | | | | | | | | | | | | | 40 | |
| | Non-urethane Diacrylate | | | | | | | | | 5 | 5 | | | | | 40 |
| | Initiator 1 | 1.2 | 1.2 | 1.2 | 1.2 | 1.8 | 1.8 | 2.4 | 1.2 | 1.2 | 1 | | 1.2 | 1.8 | 1 | 1 |
| | Initiator 2 | | | | | | | | | | 0.5 | 0.5 | | | | |
| | Non-treated CaCO3 | 60 | 50 | 60 | 60 | 19 | 19 | | 60 | 50 | 38 | 60 | 60 | 19 | 49 | 49 |
| | Treated CaCo3 | | | | | 20 | 20 | | | 10 | 10 | | | 20 | 10 | 10 |
| | Silica | | | | | | | 16.6 | | | | | | | | |
| | Antioxidant | | | | | 1 | 1 | 1 | 0.5 | 0.5 | 0.5 | | 0.5 | 1 | | |
| | Total | 100 | 100 | 100 | 100 | 100 | 100 | 100 | 100 | 100 | 100 | 100 | 100 | 100 | 100 | 100 |
| Prop- | Thickness of film (mm) | 0.5 | 0.6 | 0.4 | 0.5 | 0.8 | 0.7 | 0.9 | 0.3 | 0.5 | 0.5 | 0.05 | 1.5 | 2.0 | 0.5 | 0.5 |
| erty | Viscosity (Pa · s) | 130 | 120 | 90 | 123 | 150 | 150 | 160 | 130 | 120 | 123 | 130 | 130 | 150 | 80 | 50 |
| | rheometer 40° C., 0.42 rpm | | | | | | | | | | | | | | | |
| Results | Tensile Strength (MPa) | 2.3 | 2 | 2.1 | 2.2 | 2.5 | 2.5 | 2.8 | 2.3 | 2.2 | 2.4 | 2.1 | 2.3 | 2.5 | <0.8 | <0.8 |
| | Elongation (%) | 90 | 65 | 70 | 70 | 90 | 90 | 120 | 80 | 80 | 90 | 70 | 80 | 90 | <10 | <10 |
| | Peeling Properties Initial | ∘ | ∘ | ∘ | ∘ | ∘ | ∘ | ∘ | ∘ | ∘ | ∘ | ∘ | ∘ | ∘ | — | — |
| | After Heat 100° C. × 1 h | ∘ | ∘ | ∘ | ∘ | ∘ | ∘ | ∘ | ∘ | ∘ | ∘ | ∘ | ∘ | ∘ | — | — |
| | After Heat 160° C. × 1 h | Δ | Δ | Δ | Δ | ∘ | ∘ | ∘ | ∘ | ∘ | ∘ | Δ | ∘ | ∘ | — | — |
| | Adhesiveness after Removal | ∘ | ∘ | ∘ | ∘ | ∘ | ∘ | ∘ | ∘ | ∘ | ∘ | ∘ | ∘ | ∘ | — | — |

Values are parts by weight

Specifically, the raw materials shown in the table are as follows:
Urethane diacrylate A: Alifalic f=2 Vis30-60 Pas product name Ebecryl 230
Urethane diacrylate B: f=2 Vis35 Pas Genomer product name 4230
Urethane diacrylate C: CN9023
Urethane diacrylate D: HEA-TMDI-PPG-TMDI-HEA, f=2, PPG Mn4420
Urethane diacrylate E: HEA-IPDI-PPG-IPDI-HEA, f=2, PPG Mn3620
Urethane diacrylate F: HEA-HDI-PPG-HDI-HEA, f=2, PPG Mn4340
Non-Urethane monoacrylate: Isodecyl acrylate
Non-Urethane diacrylate: Hexapropylene glycol diacrylate
Initiator 1: Ethyl (2,4,6-trimethylbenzoyl) phenyl phosphinate Irgacure TPO-L/Genocure TPO-L
Initiator 2: 2,4,6-Trimethylbenzoyl-diphenylphosphine oxide Irgacure 819/Genocure BAPO
Surface-untreated CaCO3: Vicron 31-6/Specialty Minerals Inc. particle diameter 3.6 μm
Surface-treated CaCo3: hakuenkaCCR/Shiraishi Industry Co., Ltd. particle diameter 0.08 μm
Silica: humed silica: Aerosil 300/Evonic
Anitioxidant: AO60P/ADEKA

### INDUSTRIAL APPLICABILITY

The present invention can be used, for example, in various manufacturing processes that require masking of members. For example, the curable composition in the present invention can be suitably used as a masking material used in a manufacturing process (for example, a manufacturing process of an automobile) automated by a robot or the like.

What is claimed is:

1. A curable composition comprising:
a prepolymer (A) having an urethane/urea bond and at least two acrylic polymerizable groups, and
solid particles (B),
wherein the composition has a viscosity at 40° C. of at least 10 Pa·s and at most 300 Pa·s.

2. The curable composition according to claim 1, wherein the prepolymer (A) has (poly)oxyalkylene group represented by —[—R—O—]ₓ— wherein R represents a linear or branched alkylene group and x represents an integer of 1 to 350.

3. The curable composition according to claim 1 comprising:
a polymerization initiator (C),
wherein the polymerization initiator (C) comprises an phosphorus-containing initiator.

4. The curable composition according to claim 1, comprising the prepolymer (A) at least 25% by weight and the solid particles (B) at least 10% by weight.

5. The curable composition according to claim 1, comprising an antioxidant.

6. A curable masking material comprising the curable composition according to claim 1.

7. A producing method of a bonded body comprising:
a masking step comprising masking at least a part of a substrate surface with the curable masking material according to claim 6 to provide a masking member;
a curing step comprising curing the masking member;
an exposing step comprising peeling off the masking member to expose a part of the substrate surface; and
a bonding step comprising bonding other member to the exposed part of the substrate surface.

8. The producing method according to claim 7, further comprising,
a painting step comprising painting the substrate.

9. The producing method according to claim 7, wherein the masking step comprises applying the curable masking material at a thickness of at least 0.2 mm to mask at least a part of the substrate surface.

10. The producing method according to claim 7, wherein the masking step comprises applying the curable masking material at a width of at least 5 mm to mask at least a part of the substrate surface.

11. The producing method according to claim 7, wherein the substrate is a resin.

12. The producing method according to claim 7, wherein a robot is used.
